(19) United States
(12) Patent Application Publication
(10) Pub. No.: US 2010/0075135 A1
(43) Pub. Date: Mar. 25, 2010

(54) THERMAL GREASE ARTICLE AND METHOD

(76) Inventors: Philip E. Kendall, Woodbury, MN (US); Kanta Kumar, Maplewood, MN (US)

Correspondence Address: 3M INNOVATIVE PROPERTIES COMPANY, PO BOX 33427, ST. PAUL, MN, 55133-3427, US

(21) Appl. No.: 12/594,356

(22) PCT Filed: Mar. 7, 2008
(86) PCT No.: PCT/US2008/056188

§ 371 Date: Oct. 2, 2009

Related U.S. Application Data
(60) Provisional application No. 60/909,653, filed on Apr. 2, 2007.

(51) Int. Cl. C10M 169/02; B32B 9/04; B32B 15/20; B32B 15/04; B32B 17/06; B32B 5/16; C10M 107/50; B32B 27/32; B32B 27/30; B32B 38/10; B32B 37/00

(52) U.S. Cl. 428/323; 428/411.1; 428/446; 428/457; 428/698; 428/688; 428/426; 428/447; 428/523; 428/522; 156/249; 156/230

(57) ABSTRACT

An article including a first release liner with a first release surface, a second release liner with a second release surface, and a layer of a thermally conductive grease between the first and the second release surfaces. The thermally conductive grease includes a mixture of at least three distributions of thermally conductive particles, each of the at least three distributions of thermally conductive particles having an average (D₅₀) particle size which differs from the other distributions by at least a factor of 5.

### CROSS REFERENCE TO RELATED APPLICATION

This application claims the benefit of U.S. Provisional Patent Application No. 60/909,653, filed Apr. 2, 2007, the disclosure of which is incorporated by reference herein in its entirety.

### TECHNICAL FIELD

The present disclosure is directed to thermal management materials. More particularly, the present disclosure is directed to thermal management materials that may be used at an interface between electronic components in an electronic device.

### BACKGROUND

As electronic devices become more powerful and are supplied in ever smaller packages, the electronic components in these devices have become smaller and more densely packed on integrated circuit boards and chips. To ensure that the electronic device operates reliably, the heat generated by these components should be efficiently dissipated. For example, to enhance conductive cooling, electronic components may utilize a thermal management material as a heat transfer interface between mating surfaces of a heat generating electronic component, such as an integrated circuit chip, and a thermal dissipation member such as, for example, a heat sink or a finned heat spreader. These thermal management materials positioned at heat transfer interfaces, referred to herein as thermal interface materials (TIMs), are designed to substantially eliminate insulating air between the electronic component and the thermal dissipation member, which enhances heat transfer efficiency.

A tape or a sheet-like construction may be supplied that includes a TIM as an interlayer between an inner and an outer release liner. For automated dispensing and application, at least one of the inner release liner, the outer release liner, and the TIM interlayer may be die-cut to form a series of pre-sized pads. Once the inner release liner is removed, the pads may be bonded to a heat sink or an electronic component to form an assembly, while the outer release liner remains in place as a protective cover over the TIM. The outer layer may subsequently be removed to expose the TIM prior to installation of the assembly in an electronic device.

### SUMMARY

If the above “peel and stick” application process is to work reliably and efficiently in commercial applications, the thermally dissipative TIM material should preferably be capable of forming an interlayer, and the contact surfaces of the inner and outer release liners adjacent to the TIM interlayer should preferably release easily and reliably from the TIM during the electronic device assembly process. If the TIM interlayer has insufficient structural integrity, or the respective contact surfaces do not release completely from the TIM interlayer when the release liners are peeled away, portions of the interlayer may break away and remain on the release liner. The resulting voids reduce the effectiveness of the TIM interlayer and the fractured interlayer may cause an electronic component to be rejected during the assembly process.

Some TIMs, such as thermally conductive greases, provide excellent overall thermal conductivity, but may be difficult to apply on a liner as a uniform, thin layer. Layers of thermal greases have been applied on carrier sheets or on woven or non-woven supports, but such constructions include additional thermal interfaces and may require a thicker thermal grease layer, which reduce performance of the construction.

In general, the present disclosure is directed to a construction including a first release liner having a first release surface, a second release liner having a second release surface, and a layer of a thermally conductive grease (TCG) disposed between the first and second release surfaces.

The composition of the TCG and the composition of the first and second release surfaces are selected such that the peel force for release of the TCG layer from the first release surface is less than the peel force for release of the TCG layer from the second release surface. This allows the first release liner to be substantially stripped away while the TCG layer remains substantially intact on the second release liner.

Further, the peel force for release of the TCG layer from the second release surface is less than the peel force of the TCG layer from a surface of a selected substrate. Thus, once the TCG layer is applied on a substrate such as, for example, a mating surface of an electronic component, a heat dissipating member, or a heat distributing member, the second release liner may be stripped away while the TCG layer remains substantially intact, preferably completely intact, on the substrate.

In one aspect, the present disclosure is directed to an article including a first release liner with a first release surface, a second release liner with a second release surface, and a layer of a thermally conductive grease between the first and the second release surfaces. The thermally conductive grease includes a mixture of at least three distributions of thermally conductive particles, each of the at least three distributions of thermally conductive particles having an average (D₅₀) particle size which differs from the other distributions by at least a factor of 5.

In another aspect, the present disclosure is directed to an article including a first release liner with a first release surface, and a second release liner with a second release surface, and a layer of a thermally conductive grease between the first and the second release surfaces. The thermally conductive grease is substantially PCM-free, and at least one of the first and second release surfaces includes a fluorocarbon material, a silicone material, a fluoro-silicone material, an acrylic, or a combination thereof.

These constructions allow simple and efficient deposition of a layer of TCG the thermally conductive grease on a substrate as a thin layer of appropriate thickness and dimensions without the need for complex application equipment. The strippable release liner also may provide protection for the grease layer at intermediate stages of assembly. In some embodiments, a TCG layer on a substrate may provide improved thermal performance because the release characteristics of the release liners allow the TCG layer to be applied to the substrate more uniformly and thinly than generally possible with direct deposition methods.

In yet another embodiment, the present disclosure is directed to an electronic assembly including a substrate with at least one of an electronic component, a thermal dissipative member and a thermal distributing member. A layer of a thermally conductive grease lies on the substrate, wherein the thermally conductive grease includes a mixture of at least three distributions of thermally conductive particles, each of the at least three distributions of thermally conductive particles having an average (D₅₀) particle size which differs from the other distributions by at least a factor of 5. A release liner with a release surface lies on the layer of the thermally conductive grease.

In another embodiment, the present disclosure is directed to a method for making an electronic device, including providing a laminate with a first release liner having a first release surface, a second release liner having a second release surface, and a layer of a thermally conductive grease between the first and the second release surfaces. The thermally conductive grease includes a mixture of at least three distributions of thermally conductive particles, each of the at least three distributions of thermally conductive particles having an average (D₅₀) particle size which differs from the other distributions by at least a factor of 5. The method includes removing the first release liner to at least partially expose the layer of the thermally conductive grease, and applying the layer of the thermally conductive to a substrate. The substrate includes one of an electronic component, a thermal dissipative member or a thermal distributing member.

Other features and advantages of the invention will be apparent from the following detailed description of the invention and the claims. The above summary of principles of the disclosure is not intended to describe each illustrated embodiment or every implementation of the present disclosure. The figures and the detailed description that follow more particularly exemplify certain preferred embodiments using the principles disclosed herein.

### BRIEF DESCRIPTION OF THE DRAWINGS

FIG. 1 is a laminate construction including a TCG layer between a first release liner and a second release liner.

FIG. 2 is an electronic assembly including the TCG layer covered by the second release liner.

FIG. 3 is an electronic component having applied thereon the TCG layer.

### DESCRIPTION

All numbers are herein assumed to be modified by the term “about.” The recitation of numerical ranges by endpoints includes all numbers in that range (e.g., 1 to 5 includes 1, 1.5, 2, 2.75, 3, 3.80, 4, and 5).

In one embodiment, the present disclosure is directed to a thermal transfer construction 10 including a first release liner 30 having a first release surface 32, a second release liner 20 having a second release surface 22, and a layer of a thermally conductive grease (TCG) 40 disposed between the first and second release surfaces. The first release surface 32 is in contact with a first major surface of the TCG layer 40, and the second release surface is in contact with a second major surface of the TCG layer 40.

Suitable TCGs for use in the TCG layer 40 include materials having a bulk conductivity of greater than 0.05 W/m-K as measured by the test method Bulk Thermal Conductivity described below. Further, suitable TCGs have a viscosity of greater than 1×10³ cPs (10 Pa·s) at 1/s shear rate at 20° C. and a viscosity of less than 108 cPs at 1/sec shear rate at 125° C. All numbers herein are assumed to be modified by the term “about,” unless stated otherwise. The recitation of numerical ranges by endpoints includes all numbers subsumed within that range (e.g., 1 to 5 includes 1, 1.5, 2, 2.75, 3, 3.80, 4, and 5).

The TCGs used in the TCG layer 40 of the construction 10 are preferably substantially PCM-free or PCM-free. In this application the term substantially PCM-free refers to TCGs having less than about 1% phase change materials (PCM), while PCM-free refers to TCGs having no phase change materials (PCM) except incidental impurities. The term phase change material as used herein refers to a component that is self supporting and form stable at room temperature, but then liquefies or softens at temperatures within the operating temperature range of an electronic component. Typically, a phase change material transitions from a first phase to a second phase (for example, a melting point (Tₘ) or a glass transition temperature (T_{g}) for polymeric materials or a melting point, solidus or liquidus for metal components), within the operating temperature range of a typical electronic component (normally about 40 to about 100° C.). Use of PCM-free thermal conductive greases allows more precise control over the flow characteristics of the TCG layer 40, which may be important if the substrate to which the TCG layer is applied has a vertical orientation. PCM-free thermally conductive greases also may be applied over a greater range of temperatures, and are particularly well suited to cold plate applications in which the substrate has not reached the melt operational temperature of a PCM component. Further, thermal cycling a phase changes in the TCG layer may introduce air voids, which reduce thermal transfer performance.

Particularly preferred TCGs for use in the TCG layer 40 include those described in U.S. Publication No. 2007/0031684, U.S. Publication No. 2007/0031686, and application U.S. Ser. No. 60/824,599. Suitable TCGs include conductive particles, a dispersant, and optional carrier oil.

Suitable dispersants for use in the TCGs may be polymeric, ionic or nonionic. Ionic dispersants may be anionic or cationic. Combinations of dispersants may be used, such as, for example, the combination of an ionic and a polymeric dispersant.

Examples of useful dispersants for the TCG include, but are not limited to, polyamines, sulfonates, modified polycaprolactones, organic phosphate esters, fatty acids, salts of fatty acids, polyethers, polyesters, and polyols, and inorganic dispersants such as surface-modified inorganic nanoparticles, or any combination thereof.

Commercially available dispersants include polymeric dispersants available under the trade designations SOLSPERSE 16000, SOLSPERSE 24000, and SOLSPERSE 39000 hyperdispersants from Noveon, Inc., Cleveland, Ohio; modified polyurethanes available under the trade designation EFKA 4046 from Efka Additives BV, Heerenveen, The Netherlands; and organic phosphate esters such as those available under the trade designation RHODAFAC RE-610 from Rhone-Poulenc, Plains Road, Granbury, N.J.

The dispersants are present in an amount of at least 0.25 and not more than 50 weight percent of the TCG composition making up the layer 40, and in other embodiments, not more than 25, 10, or 5 weight percent of the total composition. In other embodiments, dispersant may be present in an amount of at least 1 weight percent and up to about 5 weight percent.

The thermally conductive particles used in the TCGs include, but are not limited to, diamond, polycrystalline diamond, silicon carbide, alumina, boron nitride (hexagonal or cubic), boron carbide, silica, graphite, amorphous carbon, aluminum nitride, aluminum, zinc oxide, nickel, tungsten, silver, and combinations thereof.

In some embodiments, it is desirable to provide a TCG having the maximum possible volume fraction thermally conductive particles that is consistent with the desirable physical properties of the resulting TCG, for example, that the TCG conform to the surfaces with which it is in contact and that the TCG be sufficiently flowable to allow easy application.

The thermally conductive particles preferred in the TCGs contain more than one distribution of conductive particles, preferably at least three distributions of thermally conductive particles. Each of the distributions of thermally conductive particles have an average particle size which differs from the average particle size of the distribution above and/or below it by at least a factor of 5, and in other embodiments, at least a factor of 7.5, or at least a factor of 10, or greater than 10. For example, a mixture of thermally conductive particles may consist of: a smallest particle distribution having an average particle diameter (D₅₀) of 0.3 micrometers; a middle distribution having an average particle diameter (D₅₀) of 3.0 micrometers; and a largest distribution having an average particle diameter (D₅₀) of 30 micrometers. Another example may have average diameter particle distributions having average particle diameter (D₅₀) values of 0.03 micrometers, 0.3 micrometers, and 3 micrometers.

The thermally conductive particles may be present in the TCGs in an amount of at least 50 percent by weight. In other embodiments, thermally conductive particles may be present in amounts of at least 70, 75, 80, 85, 86, 87, 88, 89, 90, 91, 92, 93, 94, 95, 96, 97, or 98 weight percent. In other embodiments, thermally conductive particles may be present in the TCGs of the invention in an amount of not more than 99, 98, 97, 96, 95, 94, 93, 92, 91, 90, 89, 88, 87, 86, or 85 weight percent.

Useful carrier oils for use in the TCGs include synthetic oils, mineral oils, and combinations thereof. The carrier oils are preferably flowable at ambient temperature. Specific examples of useful carrier oils include polyol esters, epoxides, silicone oils, and polyolefins or combinations thereof.

Suitable carrier oils include those available under the trade designations HATCOL 1106 (a polyol ester of dipentaerythritol and short chain fatty acids); HATCOL 2938 (trimethylol propane C8 and C10 esters); and HATCOL 3371 (a complex polyol ester of trimethylol propane, adipic acid, caprylic acid, and capric acid) from Hatco Corp., Fords, NJ; as well as those available under the trade designation HELOXY 71 (an aliphatic epoxy ester resin) from Hexion Specialty Chemicals, Inc., Houston Tex.

The carrier oil may be present in the TCGs in an amount of from 0 to about 49.5 weight percent, and in other embodiments, from 0 to not more than about 20 or about 12 weight percent of the total composition. In other embodiments, carrier oil may be present in an amount of at least 2, 1, or 0.5 weight percent of the composition. Carrier oil may also be present in the TCGs of the invention in ranges including from about 0.5, 1, or 2 to about 12, 15, or 20 weight percent.

The TCGs and TCG compositions of the invention may also optionally include additives such as antiloading agents, antioxidants, leveling agents and solvents (to reduce application viscosity), for example, methylethyl ketone (MEK), methylisobutyl ketone, and esters such as butyl acetate.

The TCGs are generally made by blending dispersant and optional carrier oil together, and then blending the thermally conductive particles sequentially, finest to largest average particle size into the dispersant/carrier oil mixture. The thermally conductive particles may also be premixed with one another, and then added to the liquid components. Heat may be added to the mixture in order to reduce the overall viscosity and aid in reaching a uniformly dispersed mixture. In some embodiments, it may be desirable to first pretreat or pre-disperse a portion or all of the thermally conductive particles with dispersant prior to mixing the particles into the dispersant/carrier mixture.

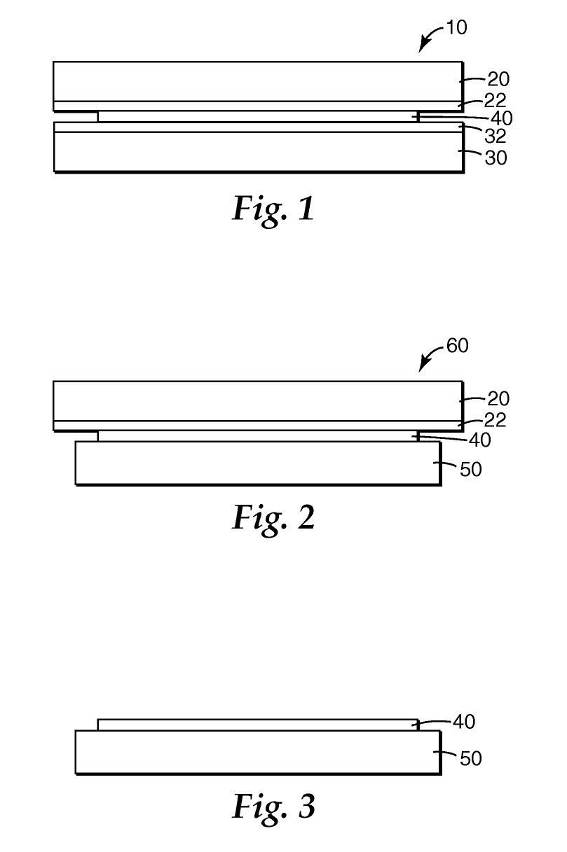

Referring again to FIG. 1, the composition of the thermally conductive grease and the composition of the first and second release surfaces 32, 22 are selected such that the peel force for release of the thermally conductive grease layer 40 from the first release surface 32 is less than the peel force for release of the thermally conductive grease layer 40 from the second release surface 22. This allows the first release liner 30 to be stripped away while the layer of the thermally conductive grease 40 remains substantially intact on the second release liner 20.

Further, as shown in FIG. 2, once the first release liner 30 is stripped away, the peel force for release of the thermally conductive grease layer 40 from the second release surface 22 is less than the peel force required to remove the thermally conductive grease from a surface of a substrate 50. Thus, as shown in FIG. 3, once the layer of the thermally conductive grease is applied on the substrate 50 such as, for example, a mating surface of an electronic component or a heat dissipating member, the second release liner 20 may be stripped away while the layer of the thermally conductive grease remains substantially intact on the substrate 50.

Referring again to FIG. 1, the first release liner 30 and the second release liner 20, having respectively first release surface 32 and second release surface 22, may be selected from materials that serve as a release surface without further modification, or may be made of a substrate having applied thereon a release coating or other surface modification. In preferred embodiments, the liners 20, 30 are flexible sheets to facilitate removal of the liner from the thermal grease.

In some embodiments, the liners 20, 30 and/or the release surfaces 22, 32 may be made of the same material. In these embodiments, it will generally be desirable to use liners of different thickness, perforations in the liners, and/or different peel angles when removing the liners to achieve the necessary difference between the first peel force to remove the first liner 30 from the TCG layer 40 and the second peel force to remove the TCG layer 40 from the second liner 20.

In other embodiments the liners 20, 30 and/or the release surfaces 22, 32 may be made of different materials. Considerations of release liner thickness, perforations and peel angles may also be useful in enhancing the use of liner/release surface pairs which differ from each other in composition.

Suitable materials for the release liners 20, 30 and the release surfaces 22, 32 include those that are easily released from the TCG layer 40, that resist deterioration due to exposure to the TCG layer 40, and those that resist absorption of the TCG layer 40. Suitable release liners include polymeric films such as polypropylene, polyimides or silicones, and metal foils, as well as substrates coated with a release coating. Suitable substrates for the release coatings include coated or uncoated papers and polymeric films such as, for example, polyethylene terepthalate (PET). Suitable release coatings include, for example, fluorocarbon materials, particularly perfluoropolyethers and fluoro-silicones, silicone materials, polyolefin materials, acrylics, and combinations thereof.

The thermally conductive grease may be applied on a substrate or liner in a conventional manner, for example, by a direct process such as spraying, dipping, casting, or extrusion, knife, roller, gravure, wire rod, or drum coating, an indirect transfer process, or by coating the entirety of the surface and then removing the coating from the first zones by scraping, etching, coronal discharge, or other means. In some embodiments, the coating will be applied in a pattern, e.g., by silk screen printing. In some embodiments, the grease may be diluted with a volatile solvent to reduce viscosity for the application step and then will be dried prior to lamination. In yet other embodiments some residual volatile material may remain in the thermally conductive grease at the time of lamination and even at the time of transfer to a substrate.

In some embodiments, the TCG layer is applied to a region of the first or second liner having the same size and shape as the desired deposit of the thermally conductive grease in the assembled article. In other embodiments, the coated region of the release liner may be larger or smaller than the contact region of the substrate to which it will be applied. In those embodiments, it is anticipated that the removal of the second release liner will take with it any excess grease or that compression of the assembly will cause the grease to spread. The TCG may be applied to either the first release surface of the first liner or the second release surface of the second release liner at the practitioner's discretion. The remaining liner is then carefully laminated on the TCG layer to avoid trapping air in the interface between the liner and the TCG layer.

The TCG layer 40 in the construction 10 in FIG. 1 may optionally include additional layers (not shown in FIG. 1) to further enhance the structural integrity of the overall construction or of the TCG layer 40, to modify the electrical and/or thermal conductivity of the TCG layer 40, or to enhance the adhesion of the TCG layer 40 to a selected substrate. However, the additional interfaces in such constructions may reduce the overall thermal conductivity of the layer 40, and are not preferred. Examples include woven or non-woven mesh materials, polymeric carrier films, metal foils or other conductive layers such as graphite layers, adhesive layers and the like.

The thickness of the TCG layer 40 in the construction 10 may vary widely depending on the intended application, and the construction 10 may be shaped to fit any desired gap between an electronic component and a heat dissipative member. Typical TCG layers 40 have a thickness of about 0.25 mils up to about 200 mils, although thinner layers of about 1 mil to about 4 mils are preferred, and layers less than about 2 mils thick are particularly preferred.

In another embodiment, the present disclosure is directed to a method of making an electronic device. Starting with the construction in FIG. 1, the first release liner 30 may be at least partially stripped to expose at least a region of the TCG layer 40. In certain preferred embodiments, the first release liner 30 releases cleanly from the TCG layer 40 with little or no grease remaining on the first release surface 32 of the first release liner 30. As shown in FIG. 2 the layer 40 may then be applied on a substrate 50 such as, for example, an electronic component or a thermal dissipative member, to form an electronic assembly 60. It is often desirable to apply mild pressure to ensure that the TCG layer 40 has wet the substrate 50 and that no air remains trapped between the TCG layer 40 and the substrate 50. In the electronic assembly 60 the second release liner 20 remains intact over the TCG layer 40 to protect the layer 40 and prevent contamination until the assembly 60 is ready for attachment to another electronic component. As shown in FIG. 3, the substrate 50 may then be prepared for attachment by stripping away at least a portion of the second release liner 20 from the assembly 60 and exposing at least a region of the TCG layer 40. As with the first release liner 30, it is preferable that the release surface 22 of the second release liner 20 releases cleanly from the TCG layer 40 with little or no grease remaining on the second release liner 20. The TCG layer 40 may then be positioned at the interface between the substrate 50 and another electronic component to form an electronic device (not shown in FIG. 3).

Specific suggested applications for the constructions 10 include, but are not limited to, attachment of a microelectronic die or chip to at least one thermal dissipation member in an electronic device. Exemplary electronic devices include a power module, an IGBT, a DC-DC converter module, a solid state relay, a diode, a light-emitting diode (LED), a power MOSFET, an RF component, a thermoelectric module, a microprocessor, a multichip module, an ASIC or other digital component, a power amplifier, or a power supply.

In some embodiments, a TCG layer 40 from the construction 10 may provide improved thermal performance because the release characteristics of the liners 20, 30 allow the TCG layer 40 to be applied to the substrate 50 more uniformly and thinly than generally possible with direct deposition methods.

Objects and advantages of this invention are further illustrated by the following examples, but the particular materials and amounts thereof recited in these examples, as well as other conditions and details, should not be construed to unduly limit this invention.

### EXAMPLES

Where not otherwise specified, materials were available from chemical supply houses, such as Aldrich, Milwaukee, Wis.

### Materials

FS10 is Sil FS10, a fluorosilicone release coating on polyester, a product of CPFilms Inc., Martinsville, VA.

6J is a fluorosilicone coating on a polyester liner, a product of Loparex, Willowbrook, IL.

2SLK is a silicone release coating on a polyester backing, a product of Mitsubish Polyester Film, Greer, S.C.

7786 is a fluorosilicone release coating on a polycoated paper. The coating solution is a product of Dow Chemical Company, Midland, Mich.

SCW106 is a silicone release liner, a product of 3M Company of St. Paul, Minn. SCW611 is a silicone release coating, described in U.S. Pat. No. 6,204,350, on a copolymer liner.

A dual side film liner, a product of Loparex Corp. as a 2 mil (50 μm) white polyethylene terephthalate coated on one side with 7300 silicone and on the other side with 7370 silicone, provided the 7370 coated liner.

A dual side film liner, a product of Loparex Corp. as a 2 mil (50 μm) white polyethylene terephthalate coated on one side with 7300 silicone and on the other side with 7380 silicone, provided the 7380 coated liner.

Suwatchpack III is an acrylic release surface coated on 2 mil (50 μm) polyethylene terephthalate, a product of 3M Company, St. Paul, Minn.

1022, 5932, and 9741 are fluorochemical release surfaces coated on either polyethylene terephthalate (1022 & 5932) or polypropylene films as taught in U.S. Pat. No. 3,849,504, U.S. Pat. No. 4,472,480, U.S. Pat. No. 4,567,073, U.S. Pat. No. 4,614,667, U.S. Pat. No. 4,820,588, U.S. Pat. No. 4,981,727, U.S. Pat. No. 4,830,910, and U.S. Pat. No. 5,306,758 being the more important ones.

9795 is a fluorosilicone release coating, as described in U.S. Pat. No. 6,204,350, on polyester film.

### Preparation of Thermal Conductive Greases

A master batch of thermal conductive interface grease, TIM A, was prepared as follows: A 1 quart Ross Mixer bowl (Model LDM 1 Qt. available from Charles Ross & Son Co., Hauppauge, N.Y.) was charged with 55.91 g Hatcol 2938 (Hatcol Corporation, Fords, NJ), 55.55 g Solsperse 16000 (Noveon, Inc., Cleveland, Ohio), 1.14 g Irganox 1010 (Ciba Specialty Chemicals, Tarrytown, NY), and Carbon Black (“XC-72R Vulcan Fluffy” from Cabot Corp., Vulcan, TX). The mix bowl was raised and the mixer was run at 50 rpm. One of the two sight glasses was removed, and through the opening was added 197.66 g of 0.0-0.25 micron diamond powder (Henan Hengxiang Diamond Abrasive Company, Zhengzhou, PR China). The mixer was allowed to run for ca. 5 minutes until the contents were judged to be thoroughly mixed and the powder fully wetted out. Through the sight glass hole was added 395.47 g of 0.5-1.5 micron diamond powder powder (Henan Hengxiang Diamond Abrasive Co.). The mixing was continued for an additional ca. 5 minutes until the contents were again judged to be thoroughly mixed and the powder fully wetted out. A final aliquot of diamond powder was added through the site glass opening, 791.01 g of 10-15 micron particle size (Henan Hengxiang Diamond Abrasive Co.). As the mixer continued to run at 50 rpm, the sight glass was replaced and a vacuum of about 737 mm (29 in) Hg was pulled on the mixer. The mixer was allowed to run an additional 90 minutes. The vacuum was released, the mix bowl was lowered and the contents transferred to a plastic container, netting 1485 g of recovered TIM A which was allowed to stand overnight.

TIM A (130.36 g) prepared above and 4.04 g. of a solvent available under the trade designation Arcosolv PM Acetate (primarily 1-methoxy-2-propanol acetate) from Lyondell Chemical Co., Houston, Tex., were transferred to a disposable cup. A lid was placed on the cup and the contents were blended on a SpeedMixer Model DAC 150FV (FlackTek, Inc., Landrum, S.C.) for two 40 second cycles at ca. 2100 rpm. The contents were allowed to cool, and then drawn into disposable syringes.

TIM B and TIM C were prepared in the following manner. The antioxidant, dispersant, and carrier fluid were all weighed into a polypropylene jar. The finest of the mineral distributions was then weighed into the cup, and the cup was capped with a corresponding screw-top lid and inserted into a SpeedMixer. The SpeedMixer was run at ca. 2000 rpm for 60 seconds. The unit was opened, the cup removed and opened, and the next coarser particle size was weighed into the cup. The cup was again closed, inserted into the SpeedMixer, and run at ca. 2000 rpm for 60 seconds. The unit was again opened, the cup removed and opened, and the coarsest particle size was weighed into the cup. The cup was closed, inserted into the SpeedMixer, and run at ca. 2000 rpm for 60 seconds. The SpeedMixer was run another cycle at 3300 rpm for 30 seconds. The resulting TIM material was stored in the mixing cup.

TIM B

| Material | Weight (g) | |
|---|---|---|
| Hatcol 2938 | 2.1174 | |
| Solsperse 16000 | 1.8377 | |
| Irganox 1010 | 0.0404 | |
| Kadox 911 ZnO | 6.5750 | (Zinc Oxide, The Gary Company, |
| | | Addison, IL.) |
| GC8000 SiC | 13.1413 | (Silicon Carbide, Fujimi Corp., |
| | | Tualatin, OR |
| 4.5-7μ Al Powder | 26.2823 | (Alpha Chemical, Ltd., Bedford, |
| | | Nova Scotia) |

The resulting grease was diluted for coating by combining 20.6857 g of the grease with 0.6480 g of Arcosolv PM Acetate using a SpeedMixer as described above.

TIM C

| Material | Weight (g) |
|---|---|
| Hatcol 2938 | 5.2763 |
| Solsperse 16000 | 3.6365 |
| Irganox 1010 | 0.0916 |
| Kadox 911 ZnO | 13.00 |
| GC8000 SiC | 26.00 |
| 4.5-7μ Al Powder | 51.98 |

The resulting grease was diluted for coating by combining 26.2571 g of the grease with 0.5852 g of Arcosolv PM Acetate using a SpeedMixer as described above.

### Preparation of Laminate Constructions Including Thermal Conductive Greases

Liners selected for evaluation following an initial screening were coated on their respective release surfaces using a notched bar knife coater with the knife set at a nominal 2 mil gap using about 1 cc of the TIM A/Arcosolv PM Acetate blend. Each coating was allowed to dry overnight at room temperature. Following drying, a second liner was laminated with the release surface against the exposed dried TIM using a hand rubber roller. The laminates were allowed to equilibrate for at least 15 minutes, and then the two liners were peeled apart. In this series of evaluations, the second liner was placed on a flat surface and a corner of the first coated liner was lifted and the remaining coated liner stripped away quickly with the liner forming less than a 90 degree angle with the second liner. Observations were made as to which liner retained the TIM. Release was judged subjectively on a 1-5 scale, where 1 was judged as poor (more than about 10% of the coating remaining on the releasing surface) and 5 was judged as excellent (clean, total transfer) to characterize how well the TIM resisted partial transfer between the liners. Results are summarized in Table 1.

TABLE 1

| Coated | Laminated | Liner with TIM | Subjective |
|---|---|---|---|
| Liner | Liner | after stripping | Rating |
| 7370 | 1022 | 7370 | 4 |
| 7370 | 5932 | 7370 | 4 |
| 7370 | 9741 | 7370 | 5 |
| 7370 | 7380 | 7370 and 7380 | 1 |
| 7370 | SCW106 | 7370 | 4 |
| 7370 | Suwatchpack III | 7370 and Suwatchpack III | 1 |
| 1022 | 7370 | 7370 | 4 |
| 5932 | 7370 | 7370 | 4 |
| 9741 | 7370 | 1022 | 5 |
| SCW106 | 7370 | SCW106 | 5 |
| 1022 | 9741 | 1022 | 5 |
| 5932 | 9741 | 5932 | 5 |
| 9741 | 1022 | 1022 | 4 |

In a separate set of experiments, the ability of TIM A to cleanly transfer from a release liner to a StarTech.com Fan478 obtained from CompUSA, Dallas, Tex., was evaluated by knife coating the TIM A to the liner to be evaluated using the coating method described above. Following lamination, the release liner was removed and the degree of transfer was evaluated using a 1-5 scale as before. The results are presented in Table 2.

TABLE 2

| Liner Designation | Subjective Rating |
|---|---|
| 1022 | 5− |
| 5932 | 5 |
| 9741 | 5+ |
| SCW106 | 5+ |
| Dual Side Film “7380 Side” | 5− |
| Dual Side Film “7370 Side” | 5 |
| Dual Side Film “7300 Side” | 3− |
| Suwatchpack III | 4 |

Further samples of TIM A were coated on release liners and laminated to a second release liner. Following lamination, the samples were aged for 10 days at room temperature prior to testing. The results are reported in Table 3.

TABLE 3

| Coated | Laminated | Liner with TIM | Subjective |
|---|---|---|---|
| Liner | Liner | after stripping | Rating |
| FS10 | 5932 | FS10 | 2 |
| 9795 | 5932 | 9795 | 2− |
| SCW611 | 5932 | SCW611 | 5− |
| 2SLK | 5932 | 2SLK | 5− |
| 7786 | 5932 | 7786 & 5932 | 1 |
| SCW106 | 5932 | 5932 | 1 |
| 9795 | 2SLK | 2SLK | 4+ |
| SCW611 | 2SLK | SCW611 | 5− |
| 5932 | 2SLK | 2SLK | 5 |
| SCW106 | 2SLK | SCW106 | 2 |
| FS10 | 2SLK | 2SLK | 1 |
| 7786 | 2SLK | 2SLK | 5− |
| 9795 | 6J | 9795 | 2 |
| SCW611 | 6J | SCW611 | 5 |
| 2SLK | 6J | 2SLK | 3 |
| 5932 | 6J | 5932 | 4 |
| SCW106 | 6J | SCW106 | 5+ |
| FS10 | 6J | FS10 | 4+ |
| 7786 | 6J | 7786 & 6J | 1 |
| 9795 | FS10 | 9795 | 3 |
| SCW611 | FS10 | SCW611 | 5+ |
| 2SLK | FS10 | 2SLK | 4+ |
| 5932 | FS10 | 5932 & FS10 | 1 |
| SCW106 | FS10 | SCW106 | 4− |
| 7786 | FS10 | 7786 & FS10 | 1 |
| 7786 | 9741 | 7786 | 4 |
| FS10 | 9741 | FS10 | 5+ |
| 9795 | 9741 | 9795 | 4+ |
| SCW611 | 9741 | SCW611 | 5+ |
| 2SLK | 9741 | 2SLK | 5+ |
| SCW106 | 9741 | SCW106 | 5+ |
| 5932 | 9741 | 5932 | 4+ |
| 6J | 9741 | 6J | 5− |

Samples of TIM B and TIM C were coated and tested for release from a 9741 release liner and for transfer to a fan assembly. The results are summarized in Table 4.

TABLE 4

| Coating | Coated | Rating on Split | Rating on transfer |
|---|---|---|---|
| Solution | Liner | from 9741 | to Fan |
| TIM B | 6J | 5+ | 5 |
| TIM B | SCW611 | 5+ | 1 |
| TIM B | 2SLK | 5− | 5− |
| TIM B | SCW106 | (Didn't laminate) | 1− |
| TIM C | 6J | 5− | 5− |
| TIM C | SCW611 | 4+ | 5− |
| TIM C | 2SLK | 5 | 4+ |

Various modifications and alterations of this invention will become apparent to those skilled in the art without departing from the scope and principles of this invention, and it should be understood that this invention is not to be unduly limited to the illustrative embodiments set forth hereinabove.

We claim:

1. An article comprising:
a first release liner comprising a first release surface;
a second release liner comprising a second release surface; and
a layer of a thermally conductive grease between the first and the second release surfaces, wherein the thermally conductive grease comprises a mixture of at least three distributions of thermally conductive particles, each of the at least three distributions of thermally conductive particles having an average (D₅₀) particle size which differs from the other distributions by at least a factor of 5.

2. The article of claim 1, wherein each of the at least three distributions of thermally conductive particles having an average (D₅₀) particle size which differs from the others by at least a factor of 7.5.

3. The article of claim 1, wherein each of the at least three distributions of thermally conductive particles having an average (D₅₀) particle size which differs from the others by at least a factor of 10.

4. The article of claim 1, wherein the thermally conductive particles comprise at least one of diamond, silicon carbide, alumina, boron nitride (hexagonal or cubic), boron carbide, silica, graphite, amorphous carbon, polycrystalline diamond, aluminum nitride, aluminum, zinc oxide, nickel, tungsten, silver, and combinations thereof.

5. The article of claim 1, wherein the thermally conductive grease comprises
0 to about 49.5 weight percent of a carrier oil;
about 0.5 to about 25 weight percent of at least one dispersant; and
at least about 49.5 weight percent of the thermally conductive particles.

6. The article of claim 1, wherein the thermally conductive grease comprises about 0.5 to about 20 weight percent of carrier oil, about 0.5 to about 25 weight percent of at least one dispersant; and at least about 49.5 weight percent of thermally conductive particles.

7. The article of claim 5, wherein the dispersant comprises at least one of nonionic dispersants, polymeric dispersants, ionic dispersants, inorganic dispersants, and combinations thereof.

8. The article of claim 1, wherein one of the at least three distributions of thermally conductive particles has an average particle size that ranges from about 0.02 to about 5 micrometers.

9. The article of claim 1, wherein one of the at least three distributions of thermally conductive particles has an average particle size that ranges from about 0.10 to about 50.0 micrometers.

10. The article of claim 1, wherein one of the at least three distributions of thermally conductive particles has an average particle size that ranges from about 0.50 to about 500 micrometers.

11. The article of claim 7, wherein the at least one dispersant comprises an ionic dispersant and a polymeric dispersant.

12. The article of claim 1, wherein the thermally conductive particles comprise a mixture of diamond and silicon carbide particles.

13. The article of claim 1, wherein the thermally conductive particles comprise a mixture of diamond and metal particles.

14. The article of claim 5, wherein the carrier oil comprises a polyol ester, an epoxide, a silicone, a polyolefin or a combination thereof.

15. The article of claim 5, wherein the carrier oil comprises a polyol ester.

16. The article of claim 1, wherein the thermally conductive grease is substantially PCM-free.

17. The article of claim 1, wherein the thermally conductive grease is PCM-free.

18. The article of claim 1, wherein at least one of the first and second release surfaces comprises a fluorocarbon material, a silicone material, a fluoro-silicone material, an acrylic, a polyolefin, or a combination thereof

19. The article of claim 1, wherein at least one of the first and the second release surfaces comprises a fluorocarbon material, a silicone material, a fluoro-silicone material, an acrylic, or a combination thereof.

20. An article comprising:
a first release liner comprising a first release surface;
a second release liner comprising a second release surface; and
a layer of a thermally conductive grease between the first and the second release surfaces, wherein the thermally conductive grease is substantially PCM-free, and wherein at least one of the first and second release surfaces comprises a fluorocarbon material, a silicone material, a fluoro-silicone material, an acrylic, or a combination thereof.

21. The article of claim 20, wherein at least one of the first and the second release surfaces comprises a fluorocarbon material, a silicone material, a fluoro-silicone material, or a combination thereof.

22. The article of claim 20, wherein the thermally conductive grease is PCM-free.

23. An electronic assembly comprising:
a substrate comprising at least one of an electronic component, a thermal dissipative member and a thermal distributing member;
a layer of a thermally conductive grease on the substrate, wherein the thermally conductive grease comprises a mixture of at least three distributions of thermally conductive particles, each of the at least three distributions of thermally conductive particles having an average (D₅₀) particle size which differs from the other distributions by at least a factor of 5; and
a release liner with a release surface on the layer of the thermally conductive grease.

24. The electronic assembly of claim 23, wherein the thermally conductive grease is substantially PCM-free.

25. The electronic assembly of claim 23, wherein the release surface comprises a fluorocarbon material, a silicone material, a fluoro-silicone material, an acrylic, or a combination thereof.

26. A method for making an electronic device, comprising:
providing a laminate comprising
a first release liner comprising a first release surface, and
a second release liner comprising a second release surface, and
a layer of a thermally conductive grease between the first and the second release surfaces, wherein the thermally conductive grease comprises a mixture of at least three distributions of thermally conductive particles, each of the at least three distributions of thermally conductive particles having an average (D₅₀) particle size which differs from the other distributions by at least a factor of 5;
removing the first release liner to at least partially expose the layer of the thermally conductive grease; and
applying the layer of the thermally conductive grease to a substrate comprising one of an electronic component, a thermal dissipative member or a thermal distributing member.

27. The method of claim 26, wherein the thermally conductive grease is substantially PCM-free.

28. The method of claim 26, wherein at least one of the first and second release surfaces comprises a fluorocarbon material, a silicone material, a fluoro-silicone material, an acrylic, or a combination thereof.

29. The method of claim 26, further comprising removing at least a portion of the second release liner.

30. The method of claim 29, further comprising attaching the layer of the thermally conductive grease to a second electronic component.

31. The method of claim 26, wherein at least one of the first and second release liners comprise a substrate comprising one of a polymer film and a paper.

32. The method of claim 31, wherein the paper comprises a coated paper.

33. The method of claim 31, wherein the polymer film comprises PET.
